(19) United States
(12) Patent Application Publication
(10) Pub. No.: US 2012/0075747 A1
(43) Pub. Date: Mar. 29, 2012

(54) SYSTEM, METHOD AND APPARATUS FOR SHAPE-ENGINEERED ISLANDS OF EXCHANGE SPRING OR EXCHANGE COUPLED COMPOSITE, BIT PATTERNED MEDIA

(75) Inventors: Elizabeth A. Dobisz, San Jose, CA (US); Michael K. Grobis, San Jose, CA (US); Olav Hellwig, San Jose, CA (US); Dieter K. Weller, San Jose, CA (US)

(73) Assignee: Hitachi Global Storage Technologies Netherlands B.V., Amsterdam (NL)

(21) Appl. No.: 12/891,961

(22) Filed: Sep. 28, 2010

(51) Int. Cl. G11B 5/127; G11B 5/73

(52) U.S. Cl. 360/110; 428/848.5; G9B/5.283; G9B/5.04

(57) ABSTRACT

A hard disk drive has a magnetic media disk comprising a substrate having an axis, and an exchange coupled, bit patterned media on the substrate arranged in a plurality of tracks. Each of the tracks has a pattern of islands extending in an axial direction from the disk. Each island comprises a first layer having a first anisotropy and a first layer radial width, and a second layer on the first layer and having a second anisotropy that is lower than the first anisotropy. The second layer radial width is less than the first layer radial width.

### BACKGROUND OF THE INVENTION

1. Field of the Disclosure

The present invention relates in general to hard disk drives and, in particular, to a system, method and apparatus for tiered islands of exchange spring or exchanged coupled composite, bit patterned media.

2. Description of the Related Art

There are significant differences between conventional (perpendicular) magnetic recording and bit patterned media (BPM) recording. For example, the linear density of conventional recording is typically about four to six times higher than the track density. In contrast, linear and track densities are similar for BPM. This difference is derived from the fact that any type of suitable BPM fabrication process is only utilized to its full potential if down-track and cross-track dimensions are similar in size. As a result, much higher track densities are anticipated for BPM recording than for conventional recording devices with equivalent areal density.

With this substantial increase in track densities, it is clear that the adverse effects of adjacent track interference (ATI) or adjacent track erasure (ATE) will become even more important than they already are in today's conventional recording structures. Therefore, pathways must be found to intrinsically limit the problems of ATI/ATE. Any technology or fabrication scheme that reduces ATI in BPM is very important to ensure exact bit addressability while increasing areal density.

### SUMMARY

Embodiments of a system, method and apparatus for shape-engineered islands for exchanged coupled composite or exchange spring, bit patterned media are disclosed. In some embodiments, a magnetic media disk comprises a substrate having an axis, and an exchange coupled, bit patterned media on the substrate arranged in a plurality of circular tracks. Each track has a pattern of islands extending in an axial direction from the disk surface. Each island comprises a first layer having a first anisotropy with a first layer radial width, and a second layer on the first layer and having a second anisotropy that is lower than the first anisotropy. The second layer radial width is less than the first layer radial width.

In other embodiments, a hard disk drive comprises an enclosure, and a magnetic media disk that rotates about an axis relative to the enclosure. The magnetic media disk has an exchange coupled, bit patterned media arranged in a plurality of tracks having a pattern of islands. Each island comprises a first layer having a first layer width and a second layer on the first layer having a second layer width that is less than the first layer width. An actuator is mounted to the enclosure and movable relative to the magnetic media disk. The actuator has a head with a head field contour for recording data to the tracks of the magnetic media disk. The head field contour has a field width that extends to adjacent tracks with minimal or no effect on the adjacent tracks.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIGS. 1A, B and C are schematic side sectional views of conventional exchange coupled composite (ECC) and exchange spring structures;

FIGS. 2A-F are schematic side sectional and top views of embodiments of ECC structures;

FIGS. 3A-F are schematic side sectional and top views of other embodiments of ECC structures;

FIG. 4 is a schematic side sectional view of an exchange spring embodiment of a bit patterned media island;

FIG. 5 is a schematic side view of other embodiments of ECC structures;

FIGS. 6A and B are schematic top and side sectional views of embodiments of ECC structures during recording operations; and

FIG. 7 is a schematic diagram of an embodiment of a hard disk drive.

The use of the same reference symbols in different drawings indicates similar or identical items.

### DETAILED DESCRIPTION

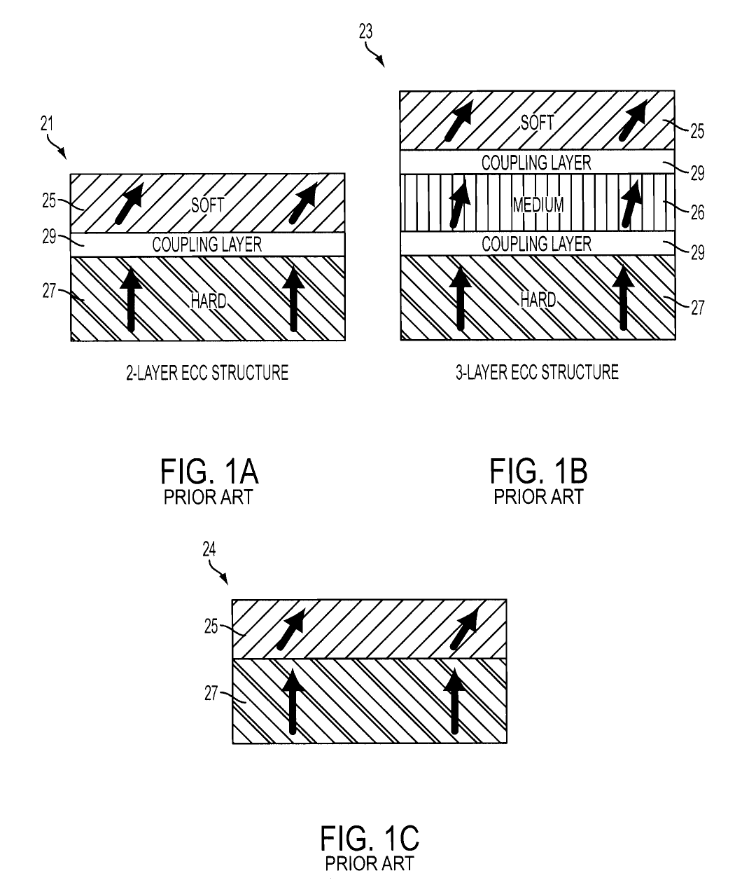

Embodiments of a system, method and apparatus for shape-engineered islands comprising exchanged coupled composite or exchange spring, bit patterned media are disclosed. FIG. 1 depicts examples of conventional two-layer and three-layer exchange coupled composite (ECC) thin film structures 21, 23, respectively, and a conventional exchange spring structure 24. These structures extend in an axial direction (i.e., illustrated vertically) and have top and bottom layers 25, 27 with different anisotropy. Structure 23 also has a middle layer 26 having an anisotropy that is between those of the top and bottom layers 25, 27. Each of the layers of these structures has substantially identical radial dimensions relative to their axes.

The top layer 25 of each structure has a lower anisotropy to help reduce the reversal field of the higher anisotropy bottom layer 27 without reducing its thermal stability. This is achieved by a reversible independent tilting of the magnetization of the lower anisotropy top layer 25, thus inducing a torque onto the magnetization of the higher anisotropy bottom layer 27.

A non-magnetic interlayer or coupling layer 29 is located between the magnetic layers of the ECC structures. Exchange spring structure 24 does not have a non-magnetic coupling layer. The thickness of coupling layer 29 is chosen thick enough so that the exchange coupling between the magnetic layers still allows an independent tilting of the magnetization of the top layer 25. However, the thickness of coupling layer 29 is chosen thin enough to trigger a joint irreversible switching of the complete media layer stack as a whole. The magnetization of the lower anisotropy upper layer needs to be able to tilt independently in a reversible manner, but once irreversible switching occurs, the magnetization of the lower anisotropy upper layer is not allowed to reverse independently without dragging the harder layers along.

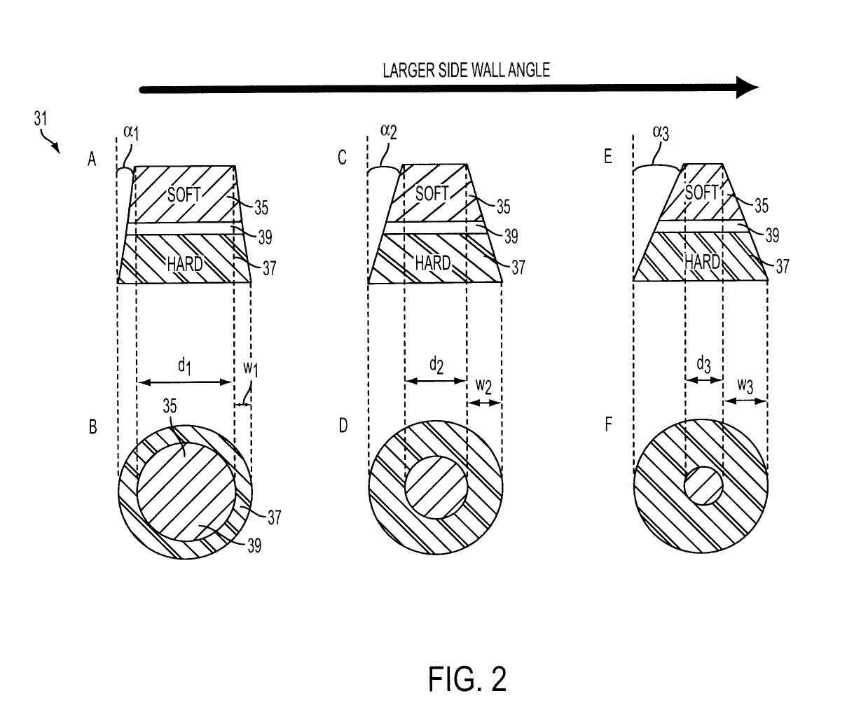

FIG. 2 schematically illustrates three different embodiments of islands 31 having a two-layer ECC thin film structure, including a top layer 35 having low anisotropy, a bottom layer 37 having higher anisotropy, and a coupling layer 39 therebetween. In other embodiments each of the top and bottom layers 35, 37 may be provided with a “graded” anisotropy that varies axially (i.e., vertically, in FIGS. 2A, C and E) within the layers. For example, a continuous gradient in anisotropy may be formed in each of the layers of the structure by changing the temperature while depositing the media layer.

The islands may comprise other ECC structures as well, and each layer may have a plurality of sub-layers. The relative lateral dimensions of hard and soft layers are tuned by variation of, for example, the side wall angle during the island fabrication and etching process.

FIGS. 2A, C and E depict side view profiles showing generally sloped or trapezoidal shaped side walls, while FIGS. 2B, D and F depict top view profiles of those respective structures, indicating their generally frustoconical three-dimensional shapes. Variation in the side wall angles (e.g., α₁, α₂, α₃) can be used to tune the relative size of the ECC core and the high anisotropy edge of the islands. For example, FIGS. 2A and B have the steepest or smallest side wall angle α₁, FIGS. 2E and F have the largest side angle α₃, and angle α₂ of FIGS. 2C and D is in between. As indicated in FIG. 5, the side wall angles do not have to be the same for different layers.

As shown in FIGS. 2B, D and F, these geometries produce top layers 35 with varying diameters d₁, d₂ and d₃, and bottom layers 37 with a varying side wall radial widths w₁, w₂ and w₃. FIGS. 2A and B have the largest top layer diameter d₁ and smallest bottom layer width w₁, FIGS. 2E and F have the smallest top layer diameter d₃, and largest bottom layer width w₃, and the diameter d₂ and width w₂ of FIGS. 2C and D are in between. In each embodiment the overall diameter of bottom layers 37 is the same.

Such lateral ring structures with an ECC core and an outer layer edge with high anisotropy reverse from the center to the edge and thus opposite to the reversal mode that may be triggered by edge damage caused during the fabrication of the islands. ECC-BPM islands shape-engineered in this manner counteract edge damage of islands or roughness in the edges during the patterning process and thus result in a better ATI performance.

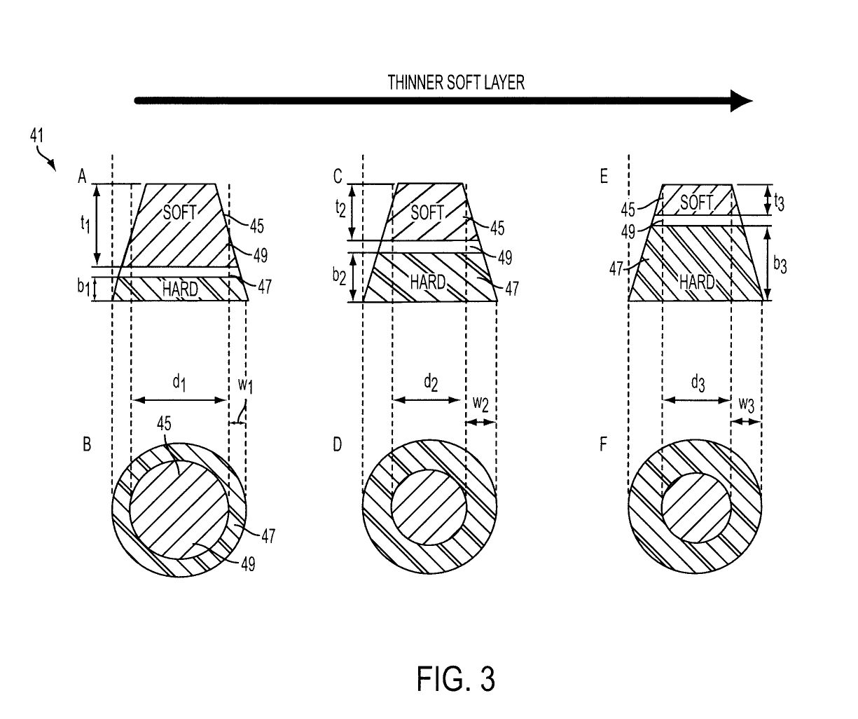

Alternatively, FIG. 3 schematically depicts additional embodiments of islands 41 having a two-layer ECC thin film structure, including a top layer 45 having low anisotropy, a bottom layer 47 having higher anisotropy, and a coupling layer 49 therebetween. These structures also may comprise graded anisotropies, as described herein. The islands may comprise other ECC structures as well, and each layer may have a plurality of sub-layers. The relative lateral dimensions of hard and soft layers are tuned by variation of, for example, the thickness of the hard and soft layers during the deposition process while keeping the side wall angle constant.

For example, FIGS. 3A, C and E depict side view profiles showing generally sloped or trapezoidal shaped side walls, while FIGS. 3B, D and F depict top view profiles of those respective structures, indicating their generally frustoconical three-dimensional shapes. Variation in the axial thickness (e.g., t₁, t₂, t₃) of the top layer 45 and bottom layer 47 (e.g., b₁, b₂, b₃) can be used to tune the relative lateral or radial size of the ECC core and the high anisotropy edge of the islands. FIGS. 3A and B have the largest top layer thickness t₁ and smallest bottom layer thickness b₁, FIGS. 3E and F have the smallest top layer thickness t₃, and largest bottom layer thickness b₃, and the thicknesses t₂ and b₂ of FIGS. 2C and D are in between.

As with the embodiments of FIG. 2, these geometries produce top layers 45 with varying diameters d₁, d₂ and d₃, and bottom layers 47 with a varying side wall radial widths w₁, w₂ and w₃. FIGS. 3A and B have the largest top layer diameter d₁ and smallest bottom layer width w₁, FIGS. 3E and F have the smallest top layer diameter d₃, and largest bottom layer width w₃, and the diameter d₂ and width w₂ of FIGS. 3C and D are in between. In each embodiment the overall diameter of bottom layers 47 is the same.

These examples illustrate how to tune the relative size of the ECC core and the high anisotropy edge of the islands by changing the relative axial thickness of each layer while retaining the desired geometry of the islands. It may be easier to change the relative thicknesses of the layer in a controlled way rather than changing the sloped shapes of the islands in order to improve and therefore reduce ATI or ATE.

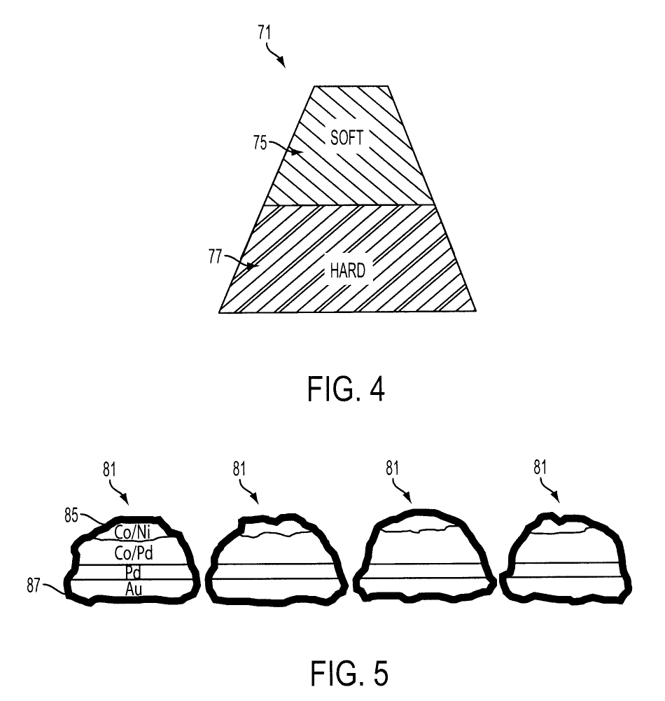

Alternatively, FIG. 4 depicts an embodiment of an exchange spring structure 71 having top and bottom layers 75, 77 with different anisotropy, and no middle or coupling layer. As described for the ECC structures, each of the top and bottom layers 75, 77 may be provided with a graded anisotropy that varies axially within the layers. Exchange spring structures such as these may be geometrically configured in a similar manner as the previous embodiments to achieve the same advantages.

FIG. 5 schematically illustrates other embodiments of ECC structures 81 having a plurality of layers that are tiered or stepped. The layers may be dome-shaped, irregular or non-symmetrical, but generally taper in radial size from the bottom layer 87 to the top layer 85. The layers may comprise numerous types of materials such as, for example, those illustrated in FIG. 5. These embodiments also provide the advantages described herein.

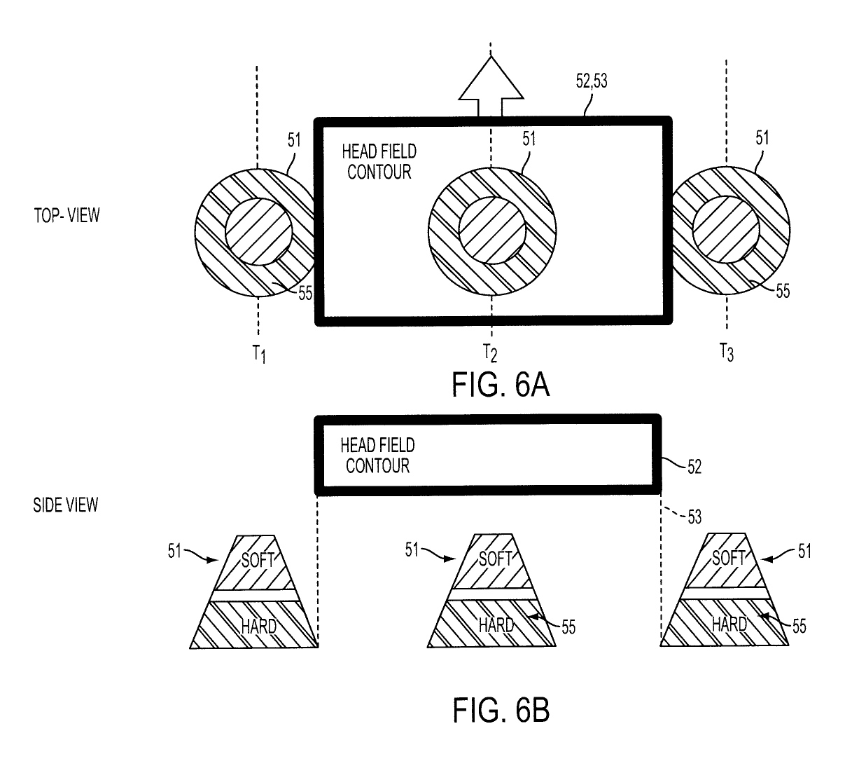

FIG. 6 illustrates how the embodiments of the media described herein reduce adjacent track interference (ATI) during recording. The islands 51 are arranged in a series of tracks T₁, T₂ and T₃. Each track has a large number of islands. A recording head 52 having a head field contour 53 is flown over a single track (e.g., T₂) of islands 51 on a rotating disk media. The head contour represents the head field region that can nucleate a reversal of the soft nucleation layer and hence the whole island. The shape of the contour may vary significantly. As best shown in FIG. 6B, the high anisotropy, outer edges 55 of the islands 51 that are adjacent to track T₂ are less susceptible to the edge stray field 53 of the recording head 52, thus reducing ATI. The reversal is preferably nucleated in the center of each island rather than at the edge, since the center has the ECC nucleation assist layer, and thus the effective switching distance for the head from island to island is increased. These embodiments do not suffer the same loss in magnetic moment, and hence read back signal, that occurs when the whole island is made smaller. The resulting media is more stable to track misregistration errors during the recording process and still maintains a good signal to noise ratio during read back.

The graded or tiered shapes of the bits can be readily obtained by physical sputtering. The media layers have a mask that is patterned on top of the media layer stack. The pattern can be generated by imprint lithography or other very high resolution lithography (e.g., extreme ultraviolet, optical, e-beam), with or without frequency doubling, or by self-assembly.

The mask may comprise an imaging layer or one or more layers deposited onto the surface and etched or lifted off. The sample with the patterned mask can be put into a vacuum system and etched by the bombardment of a beam of atoms, molecules, or ions. The magnetic material comes off the surface, usually by elastic recoil from the incident beam. The less than 90° vertical side wall may be provided by two processes. The first process is the shadowing resulting from imperfect collimation of the beam. The second process is due to imperfect etch selectivity between the mask and the etched layer(s).

In most cases the beam is not perfectly collimated and there is a small angular spread to the beam. For example, the incident beam may have a divergence angle of about +/−5°. A divergence of about 5° to 10° degrees is frequently encountered in some systems. The etch rate of the magnetic material is proportional to the flux of the incident beam. For a mask of 20 nm height, the particles in the incident beam of 5° or more do not impact the sample any closer to the patterned edge than x tan(5°), or more than 2 nm.

As the etch continues, the height of the mask and etched material increases and the distance of the shadow at the base of the trapezoid increases. In the actual case the distribution of angles is likely to be a cos² θ or Gaussian of theta. The flux of particles decreases along the depth of etched trench due to shadowing of the beam by higher features. The sample may be rotated relative to the beam. In addition to the shadowing due to divergence, an additional region may be shadowed, or hard and soft layer stacks may have different etching/milling rates. This can increase the difference between the top and bottom of the trapezoid. In both cases, the amount of shadowing (i.e., the sloped wall angle relative to vertical axis) can be decreased by increasing the thickness of the mask.

In addition to shadowing, the corners of the mask are eroded. The etch rate of the corners is generally much faster than the bulk of a material. The erosion and shape of the mask can be tailored by choice of mask materials, particle species, particle energy, and angle. In addition chemical species (such as O₂, HCF₃, etc.) can be introduced into the chamber to protect sidewalls from milling.

These embodiments have an additional advantage. Edge regions can become damaged during fabrication and serve as nucleation centers for the island reversal, which increases ATI and ATE. However, when using ECC structures with a large contrast between the hard and soft layers, as described herein, one can achieve the opposite effect and make the edges harder than the center core of the islands. These designs take advantage of the naturally trapezoidal shaped island profile in BPM structures etched or ion-milled from originally full film and decreases ATI and ATE in these structures.

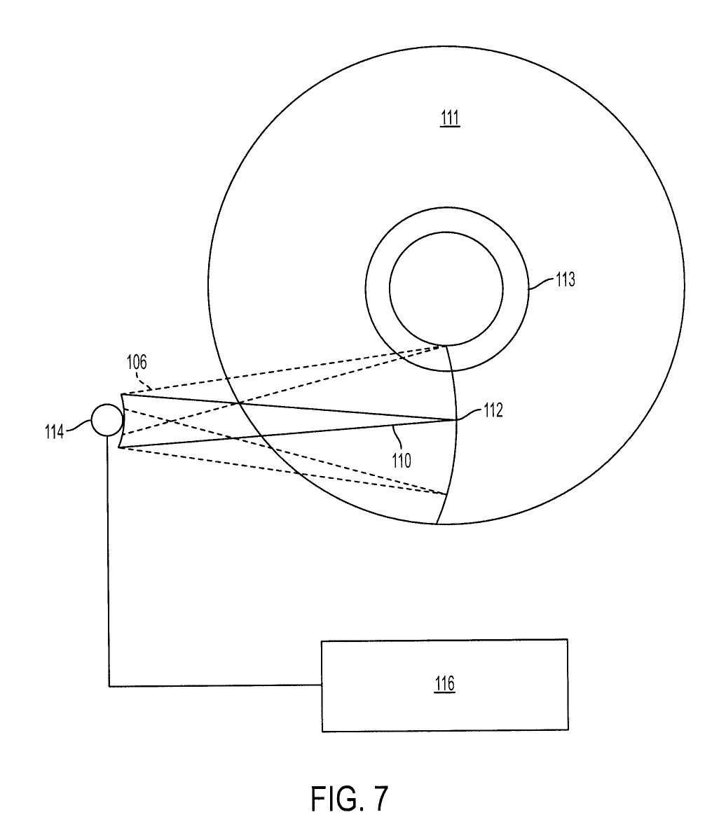

FIG. 7 depicts a schematic diagram of an embodiment of a hard disk drive assembly 100. The hard disk drive assembly 100 generally comprises a housing or enclosure with one or more disks as described herein. The disk comprises magnetic recording media 111, rotated at high speeds by a spindle motor (not shown) during operation. The concentric data tracks 113 are formed on either or both disk surfaces magnetically to receive and store information.

Embodiments of a read or read/write head 110 may be moved across the disk surface by an actuator assembly 106, allowing the head 110 to read or write magnetic data to a particular track 113. The actuator assembly 106 may pivot on a pivot 114. The actuator assembly 106 may form part of a closed loop feedback system, known as servo control, which dynamically positions the read/write head 110 to compensate for thermal expansion of the magnetic recording media 111 as well as vibrations and other disturbances. Also involved in the servo control system is a complex computational algorithm executed by a microprocessor, digital signal processor, or analog signal processor 116 that receives data address information from an associated computer, converts it to a location on the magnetic recording media 111, and moves the read/write head 110 accordingly.

In some embodiments of hard disk drive systems, read/write heads 110 periodically reference servo patterns recorded on the disk to ensure accurate head 110 positioning. Servo patterns may be used to ensure a read/write head 110 follows a particular track accurately, and to control and monitor transition of the head 110 from one track 113 to another. Upon referencing a servo pattern, the read/write head 110 obtains head position information that enables the control circuitry 116 to subsequently realign the head 110 to correct any detected error.

Servo patterns may be contained in engineered servo sectors 112 embedded within a plurality of data tracks 113 to allow frequent sampling of the servo patterns for improved disk drive performance, in some embodiments. In a typical magnetic recording media 111, embedded servo sectors 112 extend substantially radially from the center of the magnetic recording media 11, like spokes from the center of a wheel. Unlike spokes however, servo sectors 112 form a subtle, arc-shaped path calibrated to substantially match the range of motion of the read/write head 110.

In some embodiments of hard disk drive systems, a magnetic media disk comprises a substrate having an axis, and an exchange coupled, bit patterned media on the substrate arranged in a plurality of tracks. Each of the tracks has a pattern of islands extending in an axial direction from the disk surface. Each island comprises a first layer having a first anisotropy and a first layer radial width, and a second layer on the first layer and having a second anisotropy that is lower than the first anisotropy. The second layer has a second layer radial width that is less than the first layer radial width.

The exchange coupled, bit patterned media may comprise an exchange coupled composite or an exchange spring. It may further comprise a coupling layer between the first and second layers, the coupling layer having a coupling layer radial width this is greater than the second layer radial width and less than the first layer radial width. Each island may have a tiered structure formed by the first and second layers. Each island may have a generally frustoconical three-dimensional shape, and a generally trapezoidal side sectional profile.

In other embodiments of hard disk drive systems, a hard disk drive comprises an enclosure, and a magnetic media disk mounted and rotatable about an axis relative to the enclosure. The magnetic media disk has an exchange coupled, bit patterned media arranged in a plurality of tracks, each of the tracks having a pattern of islands extending in an axial direction. Each island comprises a first layer having a first layer radial width and a second layer on the first layer having a second layer radial width that is less than the first layer radial width. An actuator is mounted to the enclosure and movable relative to the magnetic media disk. The actuator has a head with a head field contour for recording data to the tracks of the magnetic media disk. The head field contour has a field width that extends to one or more previously written adjacent tracks. The field width only extends to the first layer radial widths of the first layers of the islands on the adjacent tracks and not to the second layer radial widths.

In some embodiments of hard disk drive systems, exchange coupled composite (ECC)-BPM islands or structures have unique shapes that reduce ATI/ATE. These shapes may include tapered features, such as generally frustoconical three-dimensional shapes, and generally trapezoidal shapes when viewed in side sectional profile. The islands also may have a ledge-type structure so that the top layer(s) is smaller than the bottom layer(s). Each BPM island may be provided with multiple magnetic layers that are coupled via non-magnetic interlayers at a somewhat reduced interlayer exchange. The top layers of the islands may be constructed with lower anisotropy than the bottom layers to create a graded anisotropy structure.

The interlayer coupling between the different anisotropy layers is strong enough to trigger a simultaneous irreversible switching process of the whole island. However, the interlayer coupling between the different anisotropy layers is weak enough to enable a reversible independent tilt of the lower anisotropy of the top layers. Thus, the top layers produce a torque onto the high anisotropy of the lower layers. This design acts as a nucleation assist layer for the high anisotropy of the lower layers, and lowers the overall reversal field of the complete media stack without reducing the thermal stability.

Embodiments of ECC-BPM structures as described herein have a nucleation assist layer that is present only in the center part of the island. When viewed from above, the outer edges of the island comprise only the high anisotropy material of the lower layers due to the side wall angle of the shape-engineered island. As a result, the islands have a center portion that is easier to reverse due to the low anisotropy nucleation assist layer that is present. The outer edge of the island has the nucleation assist layer missing and thus is more difficult to reverse. In such structures, the reversal occurs from the center of the island, where the lower anisotropy nucleation assist layer is present. This effect helps reduce ATI, since it becomes much more difficult to nucleate an island reversal from the edges of the islands. Thus, reversal of an island on an adjacent track becomes much less likely due to the high anisotropy edge of each individual island, and the fact that the reversal needs to be initiated in the center of the island, where the nucleation assist layer is present.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A magnetic media disk, comprising:
a substrate having an axis;
an exchange coupled, bit patterned media on the substrate arranged in a plurality of tracks, each of the tracks having a pattern of islands extending in an axial direction from the substrate, and each island comprising:
a first layer having a first anisotropy and a first layer radial width; and
a second layer on the first layer and having a second anisotropy that is lower than the first anisotropy, and a second layer radial width that is less than the first layer radial width.

2. A magnetic media disk according to claim 1, wherein the exchange coupled, bit patterned media comprises an exchange coupled composite structure or an exchange spring structure.

3. A magnetic media disk according to claim 1, further comprising a coupling layer between the first and second layers, the coupling layer having a coupling layer radial width that is greater than the second layer radial width and less than the first layer radial width.

4. A magnetic media disk according to claim 1, wherein each island has a tiered structure formed by the first and second layers.

5. A magnetic media disk according to claim 1, wherein each island has a generally frustoconical three-dimensional shape, and a generally trapezoidal side sectional profile.

6. A magnetic media disk according to claim 1, wherein at least one of the first and second layers has a graded anisotropy that varies axially within said at least of the first and second layers.

7. A magnetic media disk, comprising:
a substrate having an axis;
an exchange coupled composite, bit patterned media on the substrate arranged in a plurality of tracks, each of the tracks having a pattern of islands extending in an axial direction from the substrate, and each island comprising:
a first layer having a first anisotropy and a first layer radial width;
a coupling layer on the first layer; and
a second layer on the coupling layer having a second anisotropy that is lower than the first anisotropy, and a second layer radial width that is less than the first layer radial width.

8. A magnetic media disk according to claim 7, wherein the coupling layer has a coupling layer radial width this is greater than the second layer radial width and less than the first layer radial width.

9. A magnetic media disk according to claim 7, wherein each island has a tiered structure formed by the first, coupling and second layers.

10. A magnetic media disk according to claim 7, wherein each island has a generally frustoconical three-dimensional shape, and a generally trapezoidal side sectional profile.

11. A magnetic media disk according to claim 7, wherein the first and second layers have graded anisotropies that vary axially.

12. A hard disk drive, comprising:
an enclosure;
a magnetic media disk mounted and rotatable about an axis relative to the enclosure, the magnetic media disk having an exchange coupled, bit patterned media arranged in a plurality of tracks, each of the tracks having a pattern of islands extending in an axial direction from the disk, and each island comprising:
a first layer having a first layer radial width and a second layer on the first layer having a second layer radial width that is less than the first layer radial width;
an actuator mounted to the enclosure and movable relative to the magnetic media disk, the actuator having a head with a head field contour for recording data to the tracks of the magnetic media disk; and
the head field contour has a field width that extends to adjacent tracks, and the field width only extends to the first layer radial widths of the first layers of the islands on the adjacent tracks and not to the second layer radial widths.

13. A hard disk drive according to claim 12, wherein the exchange coupled, bit patterned media comprises an exchange coupled composite or an exchange spring.

14. A hard disk drive according to claim 12, wherein the first layer has a first anisotropy and the second layer has a second anisotropy that is lower than the first anisotropy.

15. A hard disk drive according to claim 12, further comprising a coupling layer having a coupling layer radial width this is greater than the second layer radial width and less than the first layer radial width.

16. A hard disk drive according to claim 12, wherein each island has a tiered structure formed by the first and second layers.

17. A hard disk drive according to claim 12, wherein each island has a generally frustoconical three-dimensional shape, and a generally trapezoidal side sectional profile.

18. A hard disk drive according to claim 12, wherein at least one of the first and second layers has a graded anisotropy that varies axially within said at least of the first and second layers.
